(19) United States
(12) Patent Application Publication
(10) Pub. No.: US 2008/0142695 A1
(43) Pub. Date: Jun. 19, 2008

(54) Characterisation of Glycans

(75) Inventors: Hiren Joshi, New South Wales (AU); Coran Niclas Karlsson, New South Wales (AU); Benjamin Schulz, New South Wales (AU)

Correspondence Address: BOZICEVIC, FIELD & FRANCIS LLP, 1900 UNIVERSITY AVENUE, SUITE 200, EAST PALO ALTO, CA, 94303, US

(73) Assignee: PROTEOME SYSTEMS INTELLECTUAL PROPERTY PTY LTD, North Ryde (AU)

(21) Appl. No.: 10/560,193

(22) PCT Filed: Jun. 10, 2004
(86) PCT No.: PCT/AU2004/000768

§ 371 Date: Feb. 13, 2008

(30) Foreign Application Priority Data
Jun. 11, 2003 (AU) 2003902907
Oct. 31, 2003 (AU) 2003905990

(51) Int. Cl. B01D 59/44

(52) U.S. Cl. 250/282

(57) ABSTRACT

A method for characterising the structure or sub-structure of a glycan or glycan derivative, experimentally derives the mass of an unidentified glycan molecule and compares the mass of the unidentified glycan molecule with identified and characterised glycan structures to select candidate structures for the glycan molecule. Next the mass of fragments of the glycan molecule is experimentally derived and theoretical fragmentation of the selected candidates is conducted. The mass of the fragments of the unidentified glycan molecule is matched with the mass of fragments theoretically derived from the candidate structures. Next scoring occurs to produce ranked confidence scores for each of the candidate structures by comparing the masses of the experimentally derived fragments with the masses of the theoretically derived fragments. Two scoring methods are disclosed namely segmentation and correspondence scoring. If insufficient confidence is obtained in the highest ranked score, further including the step of repeating the process by taking into account more complex cleavage patterns in the theoretical fragmentation step, or by obtaining further spectra.

### FIELD OF THE INVENTION

This invention relates to a method for characterising glycans and their derivatives, also known as oligosaccharides. In particular, the invention is a method for identifying glycan structures by correlating experimentally determined mass spectrometer fragment data with data held in a database of glycan fragments.

### BACKGROUND OF THE INVENTION

As used herein the term “glycan” will be used to describe both glycans and their derivatives unless otherwise indicated. It is known that it is possible to characterize glycan structures by correlating experimentally determined mass spectrometer fragment data with data held in a database of glycan fragments using manual interpretive methods. These methods involve researchers comparing the spectrometer fragment data with known fragment mass data. The problem with such manual methods is that they are slow and time consuming.

These problems essentially arise from the complexity of the glycan structures. The following list explains about glycans, with reference to FIGS. 1 and 2 and defines words that will be used in the remainder of the specification:

Structure—An oligosaccharide 1 consisting of monosaccharides 2 connected by glycosidic bonds 3. A set of independent monosaccharides can be arranged as a linked oligosaccharide through the glycosidic bonds between the monosaccharides. For the purposes of scoring oligosaccharide matches, the oligosaccharide is defined as having a direction—that is a particular monosaccharide is defined as a reducing end monosaccharide to which all other monosaccharides are either directly or indirectly attached. Each different arrangement of monosaccharides is an isoform of the oligosaccharide. The maximum number of oligosaccharide sequences for an m monosaccharide oligosaccharide is given by the formula m^{m-1}. This number is larger than the actual number of sequences that may be found in nature. Also, monosaccharides may share the same mass, and so not all isoforms would be unique.

Reducing end—the end of the structure r that is not involved in glycosidic linkage.

Non-reducing end—any end of the structure r that is not the reducing end of the structure.

Edges—Are located between the monosaccharides. E₁, E₂, E₃ and E₄ are the edges for the structure shown in FIG. 1.

Depth—Is the distance of the edges from the reducing end, so in FIG. 1:
depth (E₁)<depth (E₂)<depth (E₃)=depth (E₄), and
E₁ has the highest rank.

Cleavage—A carbon bond in the structure is broken. Cleavage may be: glycosidic, cross-ring and special. FIG. 2 shows cleavage at E₃ and E₄.

Glycosidic cleavage—A cleavage involving the breakage of the glycosidic bond.

Cross-ring cleavage—A cleavage involving the breaking two of the carbon-carbon bonds in one of the carbon rings of a saccharide.

Special cleavage—A cleavage which is diagnostically significant, but does not directly fall into the glycosidic or cross-ring categories.

Single cleavage—A cleavage event that involves only a single glycosidic, cross-ring or special cleavage event, ie 1-cleavage.

Multiple cleavage—A cleavage event that involves more than one cleavage event. Can be described as n-cleavage events, ie. 2-cleavage, 3-cleavage etc. FIG. 2 is an example of a 2-cleavage event.

Fragment—A result of a single or multiple cleavage event. In FIG. 2 the fragments are 21, 22 and 23.

Disjoint fragments—are fragments which do not have any common monosaccharides.

Reducing end fragment—A fragment which contains the reducing end of the structure. Fragment 21 in FIG. 2.

Non-reducing end fragment—A fragment which does not contain the reducing end of the structure. Both fragments 22 and 23 in FIG. 2.

Cleavage type—Carbohydrate fragmentation patterns are discussed in the article “A Systematic Nomenclature for Carbohydrate Fragmentations in FAB-MS/MS Spectra of Glycoconjugates” by Bruno Domon and Catherine E Costello published in Glycoconjugate J (1988) 5: 397-409, the entire contents of which are incorporated herein by reference. “Domon and Costello” notation is the accepted norm for labelling glycan fragment ions and is used herein.

Reducing end fragments may only be the result of particular types of cleavages. For 1-cleavages, these are the Y, Z, X and certain special cleavage types. For n-cleavages, reducing end fragments only occur where there are no B,C or A cleavages amongst the set of cleavages that occur. For example, reducing end fragments include Y, Z and Y/Z (Y and Z simultaneously) fragments. A B/Y fragment cannot be a reducing end fragment.

Non reducing end fragments can result from combinations of cleavage types that only include a single non reducing cleavage type. It is not possible to create a fragment from more than one non reducing cleavage type.

Peak—A peak in an MS/MS spectrum. This peak has a mass to charge (m/z) and relative intensity (relative to the largest peak in the spectrum).

Glycans may have numerous branch sites, indicated at 5 in FIG. 1, on each monosaccharide, as well as isomers and anomers. This results in complex fragmentation spectra in which the fragments observed may result from the different types of cleavage, cleavage in different locations and multiple cleavage.

1-cleavage fragments generally tend to hold more sequence information than 2-cleavages. For a 1-cleavage event, the oligosaccharide is split into two parts, one containing the reducing end and the other containing the non-reducing end section. It is possible to conclusively infer the composition of a complementary 1-cleavage fragment from the composition of a 1-cleavage fragment, since the composition of the full oligosaccharide is known. Reducing end 1-cleavage fragments are especially important for sequencing as the composition of the fragment containing the reducing end is unambiguously determined. Also, since the reducing end fragment composition is known, the composition of the non-reducing end fragment can be inferred from the difference in composition between the reducing end fragment and the full oligosaccharide.

2-cleavage events generally result in three possible fragments being created. The composition of only one of these fragments is ever fully characterised. Furthermore, the position of the reducing end monosaccharide is only disambiguated for 2-cleavage events when the fragment is a reducing end fragment. For reducing end 2-cleavage results, the composition of each of the two “lost” fragments cannot be unambiguously determined. Similarly, for a multiple reducing and non-reducing 2-cleavage, the compositions of the two complementary fragments from the main fragment cannot be unambiguously determined. Since only the composition of the parts of the oligosaccharide seen in a fragment can be accurately determined from 2-cleavage events, there is a greater degree of uncertainty about the arrangements of the monosaccharides in the complementary fragments.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this application.

### SUMMARY OF THE INVENTION

In a first broad aspect of the present invention, there is provided a method for characterising the structure or sub-structure of a glycan or glycan derivatives, comprising the steps of:

Experimentally deriving the mass of an unidentified glycan molecule.

Comparing the mass of the unidentified glycan molecule with defined glycan structures to select candidate structures for the glycan molecule.

Experimentally deriving the mass of fragments of the glycan molecule.

Theoretical fragmentation of the selected candidates.

Matching the mass of the fragments of the unidentified glycan molecule with the mass of fragments theoretically derived from the candidate structures.

Scoring to produce ranked confidence scores for each of the candidate structures by comparing the masses of the experimentally derived fragments with the masses of the theoretically derived fragments.

Such a system is able to provide high throughput characterisation of glycans by mass spectrometry, and automatic, comprehensive and rapid characterisation of glycan structures, while at the same time it supports a non-biased interpretation of mass spectra, based on the interpreters knowledge.

If insufficient confidence is obtained in the highest ranked score, the process can be repeated by taking into account more complex cleavage patterns in the theoretical fragmentation step, or by obtaining further spectra.

The initial data set used for comparison with the experimentally determined mass may consist of only fragments that are the result of 1-cleavage fragmentation. It may also include 2-cleavage events which are formed exclusively from glycosidic cleavage types. The glycosidic cleavage pattern is the parameter that contains information about oligosaccharide sequence. This limited set of fragments provides enough data for the primary sequence scoring method to work. The increase in data set size by adding more fragments is limited by refining the data set when required. This way, by restricting the types of fragments generated based upon the results of the scoring, it is possible to keep the data set size to a manageable size.

In order to characterise oligosaccharides there are two criteria that need to be fulfilled; the sequence has to be identified and the linkage configuration and position has to be determined. Information about either of the two will provide valuable data. In a broad sense mass spectrometry will be able to predict the sequence information while linkage information will be more difficult to obtain with that technique. Cross ring cleavages or specific cleavages will have the potential to enable linkage position to be determined, while the linkage anomery is the parameter that is most difficult to obtain. On a computational basis, sequencing will be able to generate in silico glycosidic and cross ring fragments solely on a mathematical basis, but information about linkage anomery can not be included. The characteristic in a fragmentation spectra that has the potential of including some information about anomery is peak intensity. This is purely since it could be envisaged that different anomeric configurations may undergo fragmentation rearrangements by different kinetics. Fragment intensities will of course also depend on other parameters.

Scoring methods will be designed to do the following:

1. Provide a quality scoring based on the sequence allowing judgement of whether the sequence at least is correct.

2. Provide a ranking between oligosaccharides based on sequence (glycosidic cleavages)

3. Provide a ranking between oligosaccharides based on linkage position (cross ring cleavages)

4. Provide a ranking between oligosaccharides based on other cleavage types including generic n-cleavages and other special cleavage types where a special cleavage is a cleavage that produces a fragment that is specific to that structure which may include the loss of water, for example.

In a further aspect a scoring method is provided involving segmentation scoring that counts the number of possible conformations for an oligosaccharide identified by a set of matching oligosaccharide fragments. By determining how well a particular conformation is supported by the evidenced fragments, it is possible to gauge the quality of match for the particular structure. The score for ordered segments (that is where the segment it connects to is known) arising from 1-cleavage fragmentation is calculated to be the number of arrangements for each segment multiplied by the maximum number of points that each segment can attach to in its next segment.

The score can be calculated as the number of arrangements of monosaccharides in the segment, and since the next segment that an ordered segment can attach to is known, it is possible to know how many points that an ordered segment will attach to.

Additional information from 2-cleavages that span the boundary between the two segments can reduce the possible number of positions that the segment can be connected to by anchoring the 2-cleavage segment.

Further adjustment may take account of uneven sub-segment size and multiple independent cleavage events.

The fragment generation process will preferably omit redundant fragments and, when known, chemically impossible fragmentations to reduce the amount of fragments and data to be processed to make the method more efficient.

The identification of glycan differences offers indicators for recognition of glycosylation differences which for example can occur on proteins, lipids or proteoglycans. These variants have been linked to disease, cell differentiation, cell communications, immunological recognition and other significant characteristics.

### BRIEF DESCRIPTION OF THE DRAWINGS

Specific embodiments of the present invention will now be described, by way of example only, and with reference to the accompanying drawings in which:

FIG. 1 illustrates the depth of edges in a glycan structure S where: depth (E₁)<depth (E₂)<depth (E₃)=depth (E₄);

FIG. 2 illustrates disjoint fragments where edges E₃ and E₄ have been cut;

FIG. 3 illustrates a non-disjoint double non-reducing end fragment;

FIG. 4 schematically illustrates a method of glycofragment mass fingerprinting;

FIG. 5a is a graph showing a spectrum of peak masses of an experimentally fragmented oligosaccharide illustrating the fragments assigned to peaks in the spectrum;

FIG. 6 shows an oligosaccharide structure of Example 1;

FIG. 7 is a graph showing the spectra of the oligosaccharide structure of FIG. 6;

FIGS. 8a to 8c are parts of a table giving the score, missed intensities and grouping score for a number of oligosaccharide structures which potentially match the oligosaccharide structure of FIG. 6;

FIG. 9 shows an oligosaccharide structure of Example 2;

FIG. 10 is a graph showing the spectra of the oligosaccharide structure of FIG. 9;

FIG. 11 shows a table giving the score, missed intensities and grouping score for a number of oligosaccharide structures which potentially match the oligosaccharide structure of FIG. 9;

FIG. 12 illustrates a 1-cleavage fragmentation segmenting an oligosaccharide into two segments;

FIG. 13 illustrates a 2-cleavage fragmentation segmenting an oligosaccharide into three segments

FIGS. 14 a, b and c illustrate the number of possible arrangements of monosaccharides of the oligosaccharide of FIG. 12 where information from a single 1-cleavage is available.

FIGS. 15 a to e are a series of diagrams illustrating the segmentation scoring process applied to a first oligosaccharide; and

FIG. 16 is a series of diagrams showing illustrating the segmentation scoring process applied to a second oligosaccharide.

### DETAILED DESCRIPTION OF PREFERRED EMBODIMENTS

The characterising process is called Glycofragment Mass Fingerprinting or GMF, and is outlined in FIG. 4:

Experiments derive the mass of an unidentified glycan molecule 40.

Theoretical work begins with a database of defined glycan structures 41 which may be a reported glycan which has been identified and characterised or a theoretical glycan structure.

Preliminary matching involves comparing the mass of the unidentified glycan molecule with the defined glycan structures to select candidate structures for the glycan molecule.

Further experiments derive the mass of fragments of the molecule 42.

Theoretical fragmentation is then performed using the selected candidates 43.

Matching 44 involves comparing the mass of the fragments of the unidentified glycan molecule with the mass of fragments theoretically derived from the candidate structures.

Scoring 45 produces ranked confidence scores for each of the candidate structures by comparing the masses of the experimentally derived fragments with the masses of the theoretically derived fragments. A number of different scoring regimes are available.

If insufficient confidence is obtained in the highest ranked score, the process can be repeated 46 by taking into account more complex cleavage patterns in the theoretical fragmentation step 43, or by obtaining further spectra.

Although mass spectrometry is the preferred method for measuring the mass of the glycan and fragmenting the glycan other methods, including chemical methods, could be used for fragmenting the glycan, although mass spectrometry will still be used for measuring the mass of the fragments. For example, glycan fragments may be generated by exoglycosidases, periodate treatment followed by acidic hydrolysis, and sulphatases.

Derive the mass of a glycan molecule 40.

A user will supply the mass of an unidentified glycan molecule from the results of mass spectroscopy.

Database of identified and characterised glycan structures 41.

A number of suitable databases are available. For example, GlycoSuiteDB available at “www.glycosuite.com” provides a database of identified and characterised glycan structures as does the database “Glycominds”. The database can be in simple table form, or can be in a relational form to exploit other information that may be associated with glycan structures such as biological source information.

Preliminary matching involves comparing the mass of the unidentified glycan molecule with the identified and characterised glycan structures to select candidate structures for the glycan molecule.

Experiments derive the mass of fragments of the molecule 42.

Individual oligosaccharides could be submitted to GMF after mass spectrometry under conditions producing fragment ions for example by tandem mass spectrometry, or in source fragmentation, or alternatively oligosaccharide mixtures could be separated into individual components with separating methods hyphenated with mass spectrometry. This includes techniques such as hplc and capillary electrophoresis. Various ionisation methods and conditions could be used. Multiple stages of mass spectrometry could also be used, where further fragmentation of fragment ions is required.

Theoretical fragmentation using the selected candidates 43.

In the present invention, a database of the theoretical peaks masses for all possible glycan fragments along with their unfragmented molecular parent mass, is produced by collating the set of theoretical fragments for an entire database of identified and characterised glycan structures.

In a refinement of the invention in order to match against and identify novel glycan structures, which are not already disclosed in existing databases, it is equally feasible to construct a theoretical database of all possible fragmentations of the much larger set of theoretically possible glycans. It is envisaged that this much larger database will be used for a second path search in which a glycan's fragment masses do not satisfactorily match to any known glycan fragment fingerprint.

In order to obtain theoretical peak masses for a Glycan structure, an algorithm is needed to generate sets of fragments for the full sets of n-cleavages for a structure. The method used for generating fragments is based on a combinatorial/permutation method. The method can be broken into two stages namely edge selection and cleavage assignment.

Edge Selection

A structure S is composed of m monosaccharides with m−1 glycosidic bonds existing between monosaccharides. In order to generate a full set of fragments for n-cleavages, we need to consider the breakage of bonds at n positions (where n<=m−1). There exists Cₙ^{m-1} combinations of glycosidic cleavage points (edges) for a n-cleavage fragmentation. In order to minimise size complexity an iterative method is used to generate all combinations of edges. E is the k-subset of the edges found in S. k can be any number up to (m−1).

For example the 2-subset is a set of all combinations of edges where two edges are combined. For the example shown in FIG. 1 there are four edges E₁, E₂, E₃, and E₄. For a double cleavage, k=2 and the k subset comprises all possible combinations of E₁, E₂, E₃, and E₄, two at a time namely (E₁, E₂), (E₁, E₃), (E₁, E₄), (E₂, E₃),(E₂,E₄), and (E₃, E₄).

The edges within each k-subset are then sorted according to depth, which produces an edge vector. Edges that involve monosaccharides closer to the reducing end, are sorted with a higher rank than edges occurring at a greater depth. For example, with reference to FIG. 1 illustrates the depth of edges in a glycan structure S where depth (E₁)<depth (E₂)<depth (F₃)=depth (E₄). Edges E₁ and E₂ are selected from that Figure being the best two edges. The k-subset of edges is (E₂,E₁) and once sorted, the edge vector will be (E₁,E₂) since E₁ is closer to the reducing end of the structure which is conventionally drawn on the right of the structure and is the end in which the hydroxide on C-1 is not extended with additional monosaccharide units. The ordering of edges is crucial to ensuring the accurate generation of fragments, as it is possible to choose particular cleavages to assign to the edges so that a disjoint fragment is generated. Thus with reference to FIG. 2 if edges E₃ and E₄ are cut, two separate fragments are created.

Carbohydrate fragmentation patterns are discussed in the article “A Systematic Nomenclature for Carbohydrate Fragmentations in FAB-MS/MS Spectra of Glycoconjugates” by Bruno Domon and Catherine E Costello published in Glycoconjugate J (1988) 5: 397-409, the entire contents of which are incorporated herein by reference. “Domon and Costello” notation is the accepted norm for labelling glycan fragment ions and is used herein.

Reducing end fragments may only be the result of particular types of cleavages. For 1-cleavages, these are the Y, Z, X and certain special cleavage types. For n-cleavages, reducing end fragments only occur where there are no B,C or A cleavages amongst the set of cleavages that occur. For example, reducing end fragments include Y, Z and Y/Z (Y and Z simultaneously) fragments. A B/Y fragment cannot be a reducing end fragment.

Non reducing end fragments can result from combinations of cleavage types that only include a single non reducing cleavage type. It is not possible to create a fragment from more than one non reducing cleavage type.

Calculating all the possible fragments is computationally intensive. Where two or more cleavages occur some of those 2-cleavages will produce fragments that will already have been accounted for in the 1-cleavages. For example the reducing end fragment produced when the two edges E₁ and E₄ are cut is also produced as a result of a 1-cleavage at E₁. The results of the E₄ cleavage are not used as E₄ did not reside on the reducing end fragment that was a result of the E₁ cleavage. Any fragments produced by a 2-cleavage, that are also produced by a 1-cleavage do not need to be calculated. Generally, when generating all n-cleavages, any fragments that could be produced by a m-cleavage (where m<n) are discarded.

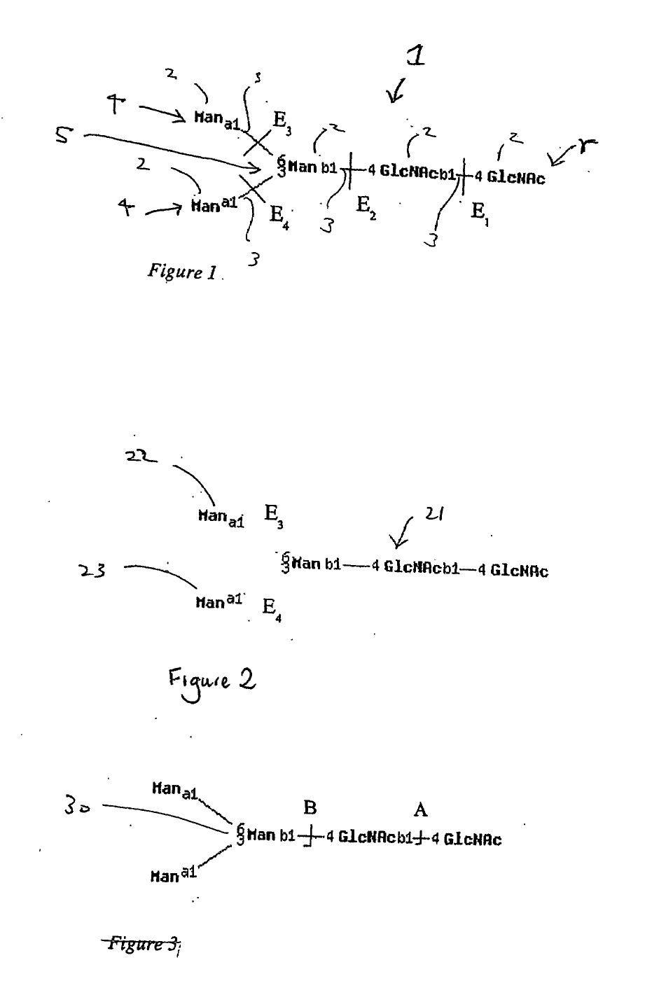

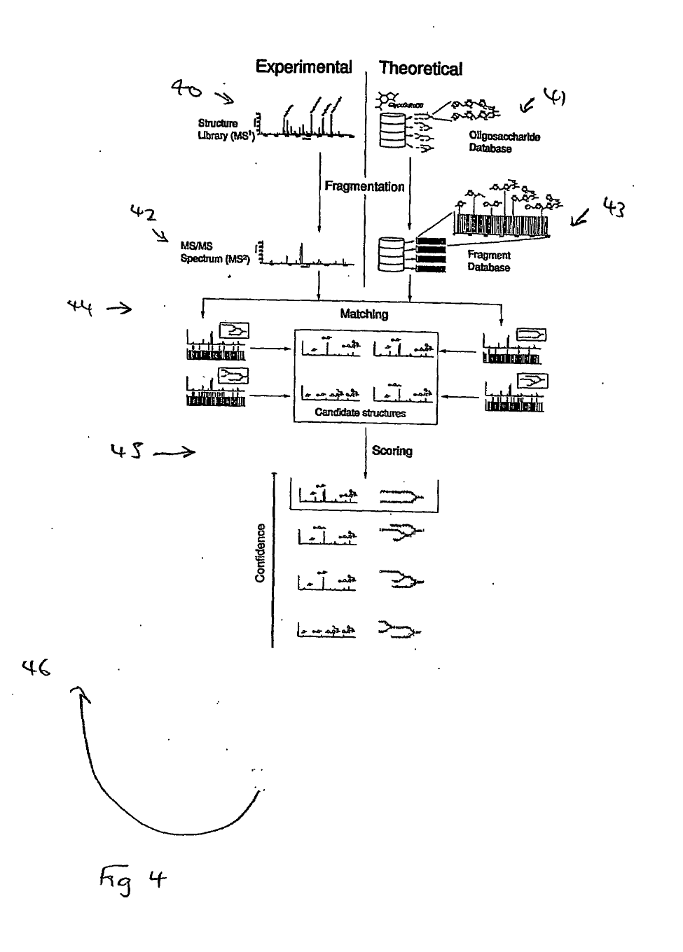

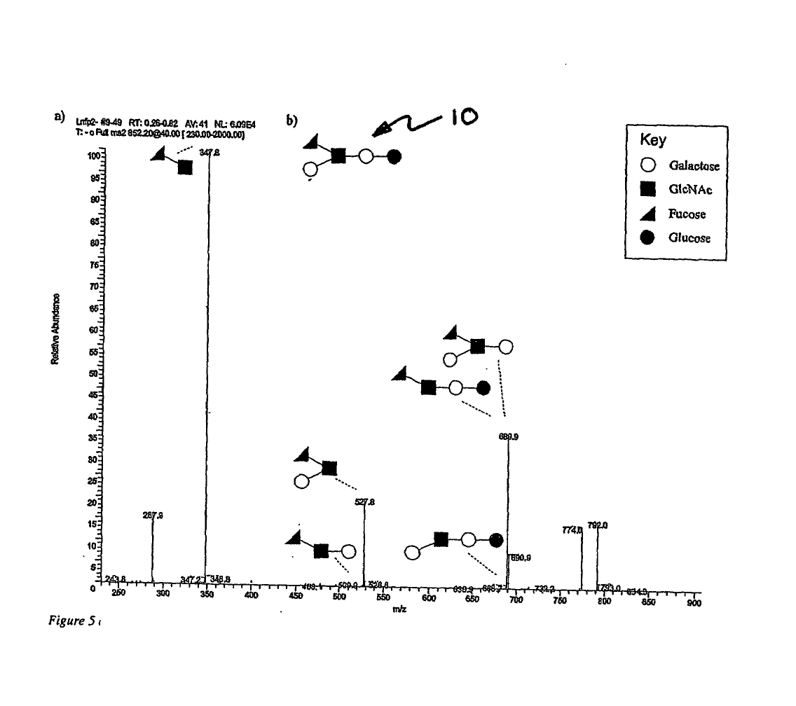

For each combination of edges obtained in the edge selection step a fragment can be generated by applying a set of fragment types to it. Referring now to FIG. 3 which shows a non-disjoint double non-reducing end fragment, consider a combination of edges formed from a 2-cleavage event consisting of Edge A and Edge B. At Edge A, the possible cleavage types that could have occurred are all reducing and non-reducing end cleavage. At Edge B, only reducing end fragments could have occurred. Only reducing end cleavages occur at Edge B as it is not possible to have two non-reducing end cleavage types resulting in a non-disjoint fragment. A fragment of this type would in fact be identical to a single cleavage occurring at the edge B with the greatest depth.

Cleavage Assignment

To assign cleavages to fragments, we map the selection of cleavage types onto each element of E.
T=the Set of n element cleavage type permutations.
for t∈T, (where the size of t is n)
∀e∈E: ∀t∈T: Fragment=(t,e) ie—(fragment type, position)

T is restricted so that each n-element permutation of cleavage types does not contain more than one non-reducing end fragment. Also, to avoid disjoint fragments occurring, the structure is checked to ensure that the structure can support the fragment. Basic checking occurs to invalidate any reducing end fragments where for a reducing end cleavage type assigned to a cleavage point, a traversal to the reducing end of the structure does not traverse any other cleavage points. Non-reducing end fragments are marked as invalid if for any of the reducing-end cleave points a traversal to the reducing end does not pass a B cleavage point. Checking occurs by starting at the cleavage point occurring at the least depth (closest to the reducing end), traversing the structure towards the reducing end, and marking any monosaccharide that is traversed over. This is repeated for the other cleavage points in the fragment. Any fragment which causes the loss of branches containing marked monosaccharides due to an A cleavage type is discarded.

Once the assignment of cleavage types to cleavage points has been verified, a virtual fragmentation occurs of the structure. This process involves removing branches from the virtual representation of the structure so that it will represent the structure of the fragment. Once the virtual fragment has been generated the mass can be obtained by looking up the masses of the remaining monosaccharides, as well as any mass losses of fragmentation types. An identifier for this fragment is created based upon the Domon+Costello notation and assigned to the fragment.

The generation of fragments is a difficult combinatorial problem. As the number of fragments dramatically increases as the number of allowed cleavages increases, it is not feasible to generate all fragments a-priori. The method of the present invention is initially performed against a smaller subset of theoretical fragments which are stored in a database. Typically the fragments for 1-cleavages, and 2-cleavages from exclusively glycosidic cleavages will initially be used.

Matching 44.

Matching involves comparing the mass of the fragments of the unidentified glycan molecule with the mass of fragments theoretically derived from the candidate structures.

Scoring 45.

A user will supply a spectrum, which consists of pairs of m/z and intensity values. Each pair is called a peak. The peak mass is converted into a true mass by adjusting for charge state and adduct, and then compared against the set of theoretical fragments to find any fragments which have a mass within the tolerance range of the peak's true mass. The fragments are then collated according to the parent structure and scored.

There are two strands to the scoring process: one to determine the sequence quality of match of a candidate structure, and another to rank the candidate structures relative to each other. The family of algorithms for each scoring type are defined as quality and relative scoring methods respectively. Based on the combination of these two scoring methods, it is possible to determine the likelihood of a result structure being the one defined by the input spectrum, in regards of sequence or linkage information or both.

Quality Scoring

The quality score for a result encapsulates how well the fragments matched for a sequence define that sequence. For example, a result structure that matches only a single small fragment will be a low quality result, whilst a structure which has many fragments matched which are distributed over the entire structure will have a high quality score. One such quality scoring algorithm is a grouping algorithm.

Group scoring derives the cleavage points from the fragment types, and obtains a number which represents how well the structure is characterised by the set of fragments associated with it. The best fragments used to characterise a structure are those resulting from 1-cleavages. If there are m−1 unique cleavage points found in a glycan structure's associated 1-cleavage fragments for a glycan having m monosaccharides, then there is enough evidence in the fragments that the sequence of the structure is valid.

Fragments resulting from 2-cleavages do not necessarily indicate the presence of a specific cleavage point in a structure. 1-cleavages are special as the presence of a fragment is enough evidence to prove that a fragment occurred at the cleavage point. 2-cleavages can be considered as a fragmentation of a fragmentation. One of the cleavage points in a 2-cleavage can be used as evidence if the other cleavage point has evidence supporting it's existence. In other words, the 2-cleavage must have an overlap with another 1-cleavage, or 2-cleavages where one of its cleavages have been assigned, for it to contain an equal amount of information. For this reason, 2-cleavages are not weighted as importantly as 1-cleavages. Any scoring method that examines cleavage points should be able to encapsulate this information. One possible algorithm involves a process of trying to fulfil each cleavage point in the original structure with a matched fragment. Whenever possible the grouping scoring algorithm will try to use a single cleavage fragment to fulfil the cleavage point. If the cleavage point cannot be fulfilled by a 1-cleavage fragment, it will use a 2-cleavage fragment. The actual score assigned is derived using:

Score=(a−0.25b)/(m−1) Equation 1

where a is the number of cleavage points assigned to 1-cleavage events, and b is the number of cleavage points assigned to 2-cleavage fragments. A structure whose cleavage points are strongly supported by it's fragments is assigned a score closer to 1. This method can be extended to handle generic n-cleavages where n is greater than 1, by extending the formula to appropriately weight the importance of the cleavages and further subtracting those from a.

It should be noted that the above is only one simple type of scoring equation and that other equations could be used to perform the same function encapsulating the information from both single and double cleavages.

Segmentation Scoring

Segmentation scoring is a qualitative scoring method that counts the number of possible conformations for an oligosaccharide identified by a set of matching oligosaccharide fragments. By determining how well a particular conformation is supported by the evidenced fragments, it is possible to gauge the quality of match for the particular structure.

Simple Segmentation

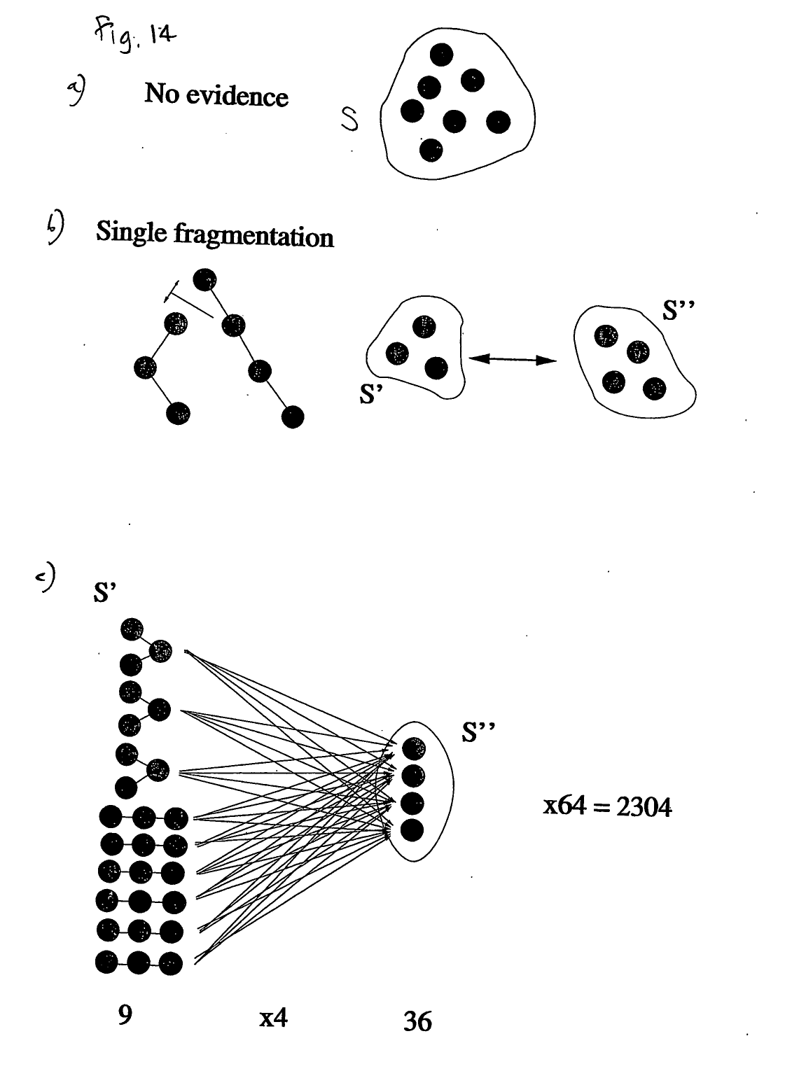

A 1-cleavage fragmentation that occurs on an oligosaccharide can be considered as evidence of particular sequence characteristics of the oligosaccharide. For example, with reference to FIG. 12, consider an oligosaccharide where a 1-cleavage fragmentation occurs at a glycosidic bond. This fragmentation provides two pieces of evidence about the sequence. We can consider the fragmentation to have split the oligosaccharide into two parts—S′ and S″. Both S′ and S″ are segments of the oligosaccharide. A segment of an oligosaccharide is itself an oligosaccharide, and is used to help measure the worth of evidence of a particular experimentally observed fragmentation.

S″ contains the reducing end of the oligosaccharide somewhere within its set of monosaccharides. All monosaccharides contained within S″ can attach to the reducing end, or form chains of monosaccharides terminating at the reducing end monosaccharide. For the monosaccharides contained in S′ to be attached to the reducing end, there must be a single child monosaccharide connected from S′ to S″. A monosaccharide in S″ cannot be a child of a monosaccharide in S′. That is, any monosaccharide in S″ is closer to the reducing end than any monosaccharide in S″.

This fragmentation provides three pieces of evidence about sequence for this oligosaccharide:

all monosaccharides within S′ must be connected to at least one monosaccharide in S′

all monosaccharides within S″ must be connected to at least one monosaccharide in S″

a single monosaccharide in S′ is connected to another monosaccharide in S″. These three pieces of evidence can be used to construct a set of oligosaccharides which can support a fragment with an identical mass to the found fragment. Further evidence, such as the composition of the full monosaccharide is also used to construct these oligosaccharides.

Although it is algorithmically possible to create and sequence all possible structures which may support this fragmentation, it is only necessary to count the number of structures that will be generated. The total number of structures can be calculated by enumerating both the possible arrangements of a segment, and the number of ways that a particular segment may be attached to another segment. For S′, we can calculate the number of possible arrangements of the monosaccharides contained in S′ using the formula m^{m-1}. Similarly, S″ can be arranged in nⁿ⁻¹ ways. To calculate the number of ways that S′ can be attached to S″, we consider the number of positions that the reducing end monosaccharide from S′ can attach to a monosaccharide in S″. Since S″ comprises n monosaccharides, there are n possible attachment positions. In total, there are nⁿ⁻¹×m^{m-1}×n possible arrangements of monosaccharides.

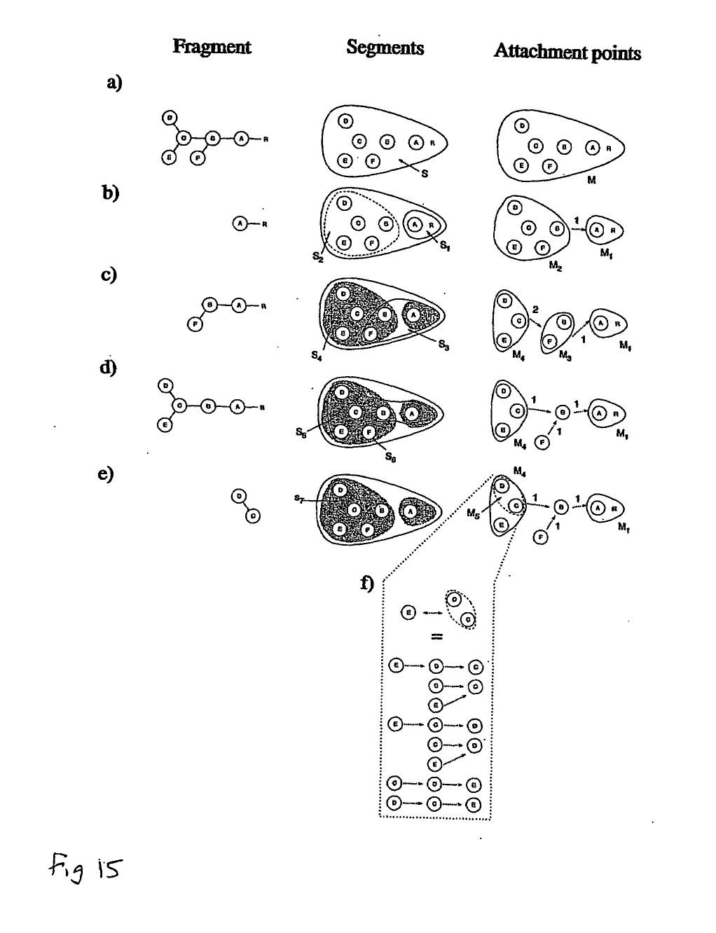

For example, with reference to FIGS. 14a to c there are 3²×4³×4=2304 possible arrangements, illustrated in FIG. 14c.

Complex Segmentation

Although segmentation is simple for a single fragment, multiple fragments significantly complicate the process of segmentation.

2-Cleavage Fragmentation

This is illustrated with reference to FIG. 13. There are two cases for the segmentation resulting from a 2-cleavage event:

Reducing end 2-cleavage event—When a reducing end 2-cleavage event fragment is used as evidence for segmentation, it segments the oligosaccharide into three segments. S″ and S′″ can attach to any position in S′, since the evidence is only for two glycosidic cleavages to have occurred.

Non-reducing end 2-cleavage event—A non-reducing 2-cleavage event also creates three segments. Since no directional information is stored in this fragment, and the reducing end may be contained in S″ or S′″. S′ may be attached to any of S″ or S′″. Similarly, S″ may be attached to S′ or S′″ and S′″ may be attached to S′ or S″. There are 9 possible ways that S′, S″ and S′″ can be arranged together. Let S′ contain x monosaccharides, S″ y monosaccharides, and S′″ z monosaccharides. The full structure contains m monosaccharides. There are

9×x^{x-1}×y^{y-1}×z^{z-1}×(y×z)×(x×z)×(x×y) possible arrangements of oligosaccharides to fulfil these conditions.

Multiple Independent 1-Cleavage Events

Multiple 1-cleavage events complicate the segmentation process by introducing nested segments. A nested segment is a segment created from a segmentation of an existing segment. The original segment will change from containing a set of monosaccharides, to a set of segments. Segments are created by considering fragmentation evidence from the non-reducing terminal monosaccharides and working towards the reducing end. As each piece of fragmentation evidence is applied to the segmentation, the segment containing the reducing end is further segmented. A complex set of rules for creation of structures is created by this refinement of segmentation, resulting in a reduction in the number of possible structures that can be created with each successive fragment accounted for as evidence. Once all 1-cleavage events have been accounted for, a set of segments with defined relationships between each other are found.

Multiple 2-Cleavage Events

A set of segments along with information regarding which segments are definitely attached to other segments is created at the end of the previous stage. For any segments which contain more than one monosaccharide, further fragments are interrogated to find any further evidence of sequence. 2-cleavage reducing end cleavages are treated by intersecting the segments created by the 2-cleavage event with the existing segments. Other 2-cleavage events can only be relied on for the grouping of monosaccharides in the fragment. This grouping of monosaccharides is also treated as a segment, and intersected with the existing segments. Once all fragments have been used to create segments, the oligosaccharide is maximally segmented, i.e. all groupings of monosaccharides have been merged to produce the smallest groups of monosaccharides possible.

Calculating the Score

The score is calculated by calculating the score for the ordered segments, which in turn calculates the score for unordered segments. The ordered segments are segments where the segment that it connects to is known. Ordered, segments arise from 1-cleavage fragmentation. To calculate the score for ordered segments, the number of arrangements for each segment is calculated, which is then multiplied by the minimum number of points that each segment can attach to in its next segment.

$$Score = {\prod }_{non reducing segments}^{reducing end segment} score ( segment ) \times minimum number of positions that segment can attach at$$

The score of each segment is calculated in one of two ways. If the segment has been sub-segmented by 2-cleavage fragmentation, a method detailed later is used. If no further sub-segmentation has occurred, the score is calculated as the number of arrangements of monosaccharides in the segment. Since the next segment that an ordered segment can attach to is known, it is possible to know how many points that an ordered segment will attach to. With no additional information, the segment can attach to as many monosaccharides as there are in the next segment. Additional information from 2-cleavages that span the boundary between the two segments can reduce the possible number of positions that the segment can be connected to by essentially anchoring the 2-cleavage segment. When there are no ordered segments identified, the entire oligosaccharide is treated as one big segment, and the score is calculated using 2-cleavage fragments if possible.

$$score ( segment ) = \frac{\begin{matrix}arrangements ( subsegments ) \times \\ {\prod }_{s ∈ subsegments} score ( s ) \times number of attachments points\end{matrix}}{number of anchoring segments}$$

The number of arrangements of sub segments is given by the above formula. A further adjustment of the number of structures created has to be performed due to uneven sub-segment size. For sub-segments that are larger than a single monosaccharide big, the number of arrangements is increased based upon the number of sibling sub-segments. The number of attachment points is given by finding the smallest sub-segments of a sub-segment that the sub-segment has in common with its sibling segments. The number of anchoring segments is the number of sub-segments that the segment has grouped together with the segments from a sibling segment.

Contrasted Intensities

In order to further discriminate between matches using the segmentation scoring method, the contrasted intensity score is used. The contrasted intensity score is applied in two stages. The first stage looks at the total intensity matched to glycosidic cleavage fragments for a match in comparison to the total intensity matched to glycosidic cleavages for the other candidate structures. The second stage compares total intensity matched to cross-ring cleavages, and other fragment types.

### EXAMPLE 1

We define the segments marked by Sₓ, where x is any number, to be the segments directly resulting from the mapping of a fragment to the structure.

Segments marked with Mₓ, where x is any number, are segments that are derived from the mapping of fragments to the structure as well as the intersection of different Sₓ fragments.

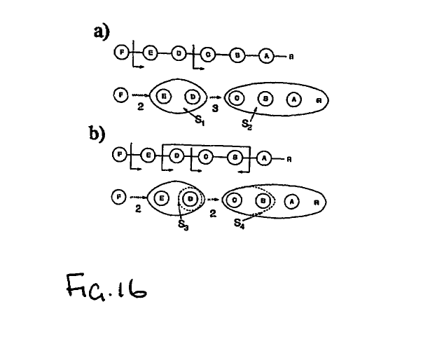

Consider the hexasaccharide shown in FIG. 15, where the structure mass, shown in a) and four fragment masses (b-e) have been found. Initially, no rules are known about the arrangement of monosaccharides in the structure.

a)

With no fragments, the structure is segmented into a single segment containing all monosaccharides.

Rules

(1) S={A,B,C,D,E,F}

(2) M=S

$$Arrangements = arrangements ( M ) \\ = {6}^{5} = 7776$$

where arrangements is a function calculating the arrangements of a segment. The attach function (seen later) is the number of points that a segment can attach to another segment with.

This is a purely mathematical number of arrangements of the monosaccharides in the structure, and does not accurately reflect reality, where the number of arrangements is limited by the number of possible attachment points for each monosaccharide.

b)

A fragment resulting in the loss of monosaccharides B-F or alternatively the loss of A only is found. Fragments resulting in the loss of B-F and fragments resulting in the loss of A are complementary. The segments M₁ and M₂ are created from the intersection of the new segments (S₁ and S₂) and the existing segment (S).

Rules

(3) S₂={B,C,D,E,F}

(4) S₁={A}

(5) S₂→S₁

(6) M₁=S∩S₁

(7) M₂=S∩S₂

$$Arrangements = arrangements ( {M}_{2} ) \times attach ( {M}_{2} \to {M}_{1} ) \times arrangements ( {M}_{1} ) \\ = {5}^{4} \times 1 \times 1 = 625$$

c)

Rules

(8) S₃={A,B,F}

(9) S₄={C,D,E,}

(10) S₄→S₃

(11) M₃=S₂∩S₃

(12) M₄=S₂∩S₄

$$Arrangements = arrangements ( {M}_{4} ) \times attach ( {M}_{4} \to {M}_{3} ) \times arrangements ( {M}_{3} ) \times attach ( {M}_{3} \to {M}_{1} ) \times arrangements ( {M}_{1} ) \\ = {3}^{2} \times 2 \times 2 \times 1 \times 1 = 36$$

d)

This is the final 1-cleavage cleavage event to be turned into a segment. There is variability within M₄, but the rest of the structure has all of its sequence fully supported.

Rules

(13) S₅={A,B,C,D,E}

(14) S₆={F}

(15) S₆→S₅

$$Arrangements \\ = arrangements ( {M}_{4} ) \times attach ( {M}_{4} \to B ) \times arrangements ( F ) \times attach ( F \to B ) \times arrangements ( B ) \times attach ( B \to {M}_{1} ) \times arrangements ( {M}_{1} ) \\ = {3}^{2} \times 1 \times 1 \times 1 \times 1 \times 1 \times 1 = 9$$

e)

The 2-cleavage event only contains information about the grouping of monosaccharides, and does not contain information about complementary fragments. As such, we can only add a single rule to the set of rules. The number of arrangements for M₄ is calculated in (f).

Rules

(16) S₇={C,D}

$$Arrangements = arrangements ( {M}_{4} ) \times attach ( {M}_{4} \to B ) \times arrangements ( F ) \times attach ( F \to B ) \times arrangements ( B ) \times attach ( B \to {M}_{1} ) \times arrangements ( {M}_{1} ) \\ = 6 \times 1 \times 1 \times 1 \times 1 \times 1 \times 1 = 6$$

f)

M4 is split into two segments M₅ and a segment containing only E. There are two arrangements of this segment M₅→C,C→M₅. M₅ can only attach to E in a single position, but E can attach to M₅ in more positions. To account for this, an adjustment for the number of attachment positions is used to modify the number of arrangements of M₄. In this example, the number of arrangements of M₄ is increased from 4 to 6.

### EXAMPLE 2

a)

Referring to FIG. 13 two single fragments have been found for this structure. It is split into three segments: S₁, S₂ and a segment containing only F. F can attach to S1 at two positions (E,D), and S2 can attach to S1 at three positions (A,B,C). The total number of arrangements possible is 108.

b)

A 2-cleavage event is used to segment the structure from a). A resulting segment from this cleavage spans two 1-cleavage segments. In this case, the 1-cleavage segments are sub-segmented. Let the segment that this 2-cleavage would have created be S′.

S′={B,C,D}

S₃=S₁∩S′={E,D}∩{B,C,D}={D}

S₄=S₂∩S′={A,B,C}∩{B,C,D}={B,C}

Also, we know that S₃ must attach to S₄. Because of this, S₁ can only attach to S₂ via B and C. If S₁ attached to S₂ via A, the rule governing S′ would be violated. Since S₄ must attach to S₃, the number of arrangements of S₃ is reduced so that this rule can be accommodated. There are now only 24 arrangements of monosaccharides supported by this fragmentation. The number of positions that S₁ attaches to S₂ was reduced to 2, the number of arrangements of S₁ was reduced to 1 (D must be used to attach to S₂, and cannot attach to both E and S₂). Also, the number of arrangements of S₂ was reduced to 6.

Relative Scoring

Relative scoring methods will allow for differentiation of results which have the same quality score. One method which can be used is a matched intensity scoring method. Matched intensity can also be further refined into matched sequence (only glycosidic cleavages) intensity and linkage information (cross ring, special cleavages with or without concomitant glycosidic cleavages) intensity.

Matched intensities obtains the sum of intensities of all peaks which have matched with at least one fragment within a fragment subset (eg glycosidic, cross ring, or both together). A peak matching with at least one fragment suggests that there is a possible fragmentation that can support this peak mass. Structures which are more correct will have a greater number of spectrum peaks matching with any fragments. The matched intensity score is particularly useful for distinguishing between isomers of structures, which may otherwise have an identical grouping score. The matched intensity score will determine the quantity of diagnostic fragments that have matched, and a difference in score suggests a difference in matched fragments.

Iteration 46.

Based on the scoring, the data set size is further increased by adding more fragment types, and the process is performed again. The process can only be repeated until the experimental data set is exhausted of the required information, i.e. no unique fragments can be found that distinguish particular oligosaccharide candidates. In order to improve efficiency, only a portion of the spectrum may need to be used, or the process may only be performed against fragments which are the result of certain structures being fragmented. A structure which has at least one fragment which matches with a peak true mass will have a set of fragments associated with it. This fragment set is the set of fragments derived from the structure which have matched with the spectrum peak true masses.

The initial data set used for GMF consists of only fragments that are the result of 1-cleavage fragmentation as well as 2-cleavages which are formed exclusively from glycosidic cleavage types. This limited set of fragments provides enough data for the primary sequence scoring method to work. The increase in data set size by adding more fragments is limited by refining the data set when required. This way, by restricting the types of fragments generated based upon the results of the scoring, it is possible to keep the data set size to a manageable size.

In order to increase the accuracy of the GMF process without sacrificing speed, the data set against which GMF is performed is refined. For the initial data set used in GMF, not all of the structures returned will be valid candidate structures for the spectrum, as they may not have the right sequence. In order to exploit this, a more detailed GMF can be performed against the more likely structures out of the current result set. Extra fragments can be retrieved either from a slower secondary storage device, or generated on the fly for detailed GMF queries. It is not necessary for the entire GMF solution space for fragments to be available in every GMF query. By taking advantage of properties of the sugar structure fragmentation patterns, it is possible to target the data set for each GMF query to contain only relevant data.

As the data sets become more refined, and the possible solution set more relevant, the matched intensity score will increase. Initial data sets will contain generic fragments, and will not match more exotic fragments which may occur. However, these exotic fragments may not necessarily be useful in determining the correct result out of a large result set. For example, the intensity of the peak matching the fragment may be very low, or the fragment occurs in many of the structures. As the result set is reduced in size the importance of these fragments increases, and they play a very important role in the selection of the most probable candidate structure.

Results

FIG. 5 shows a graph of peaks from fragmentation of a glycan structure 10.

Peak m/z 689.9 has been matched with two different fragments having the same mass. Further information is required to determine whether both the fragments that have matched, or a single one is the correct fragment.

### EXAMPLE 1

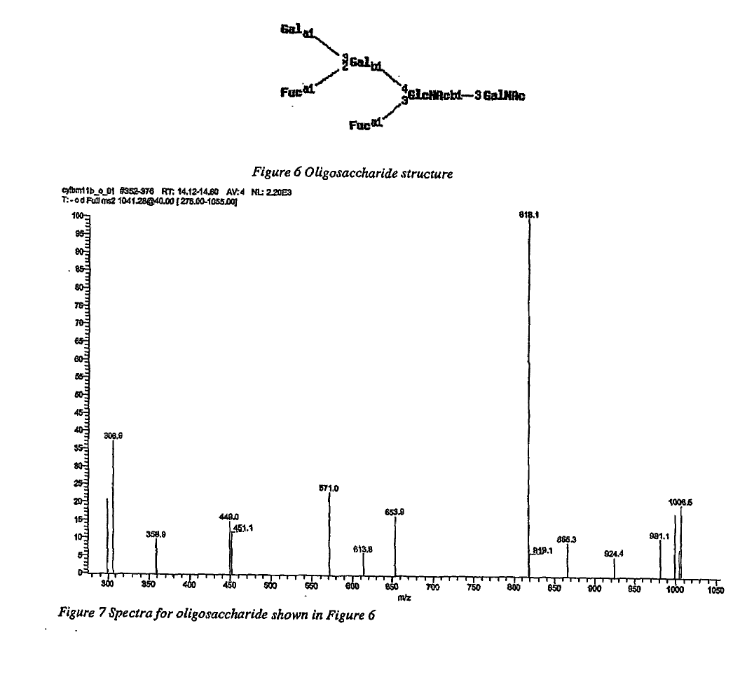

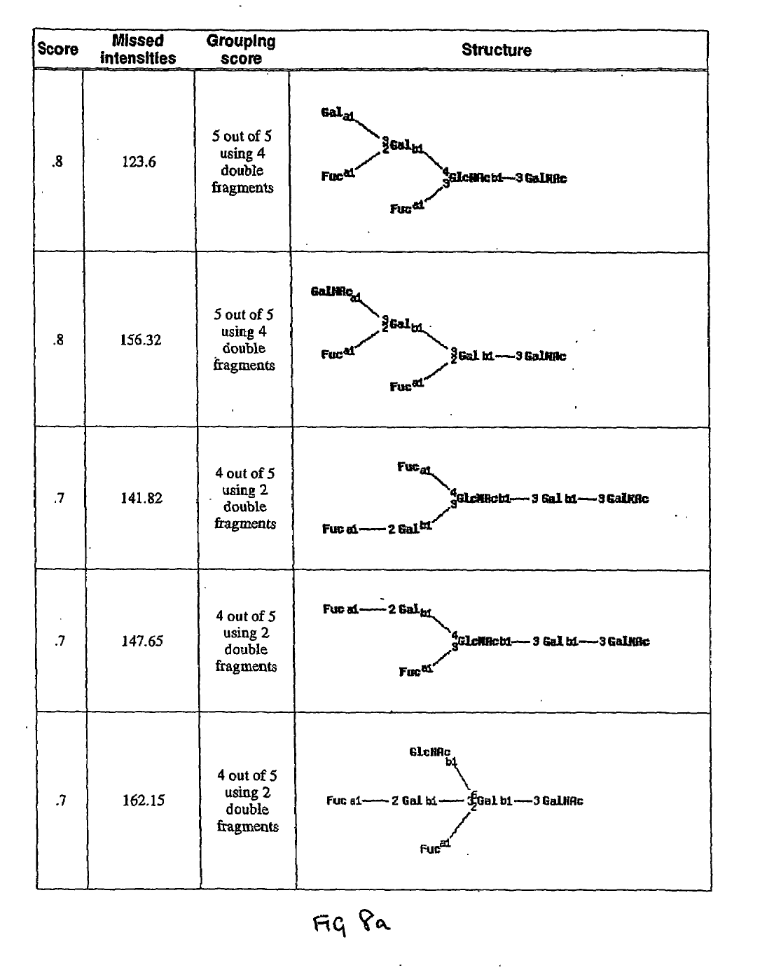

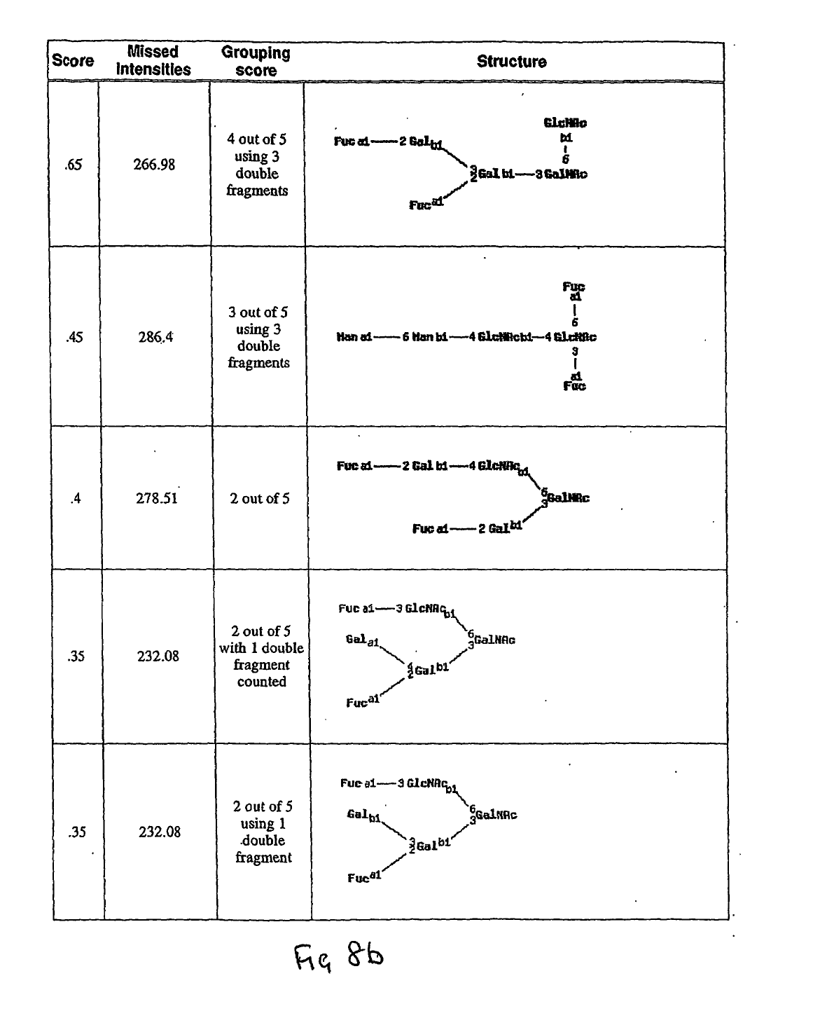

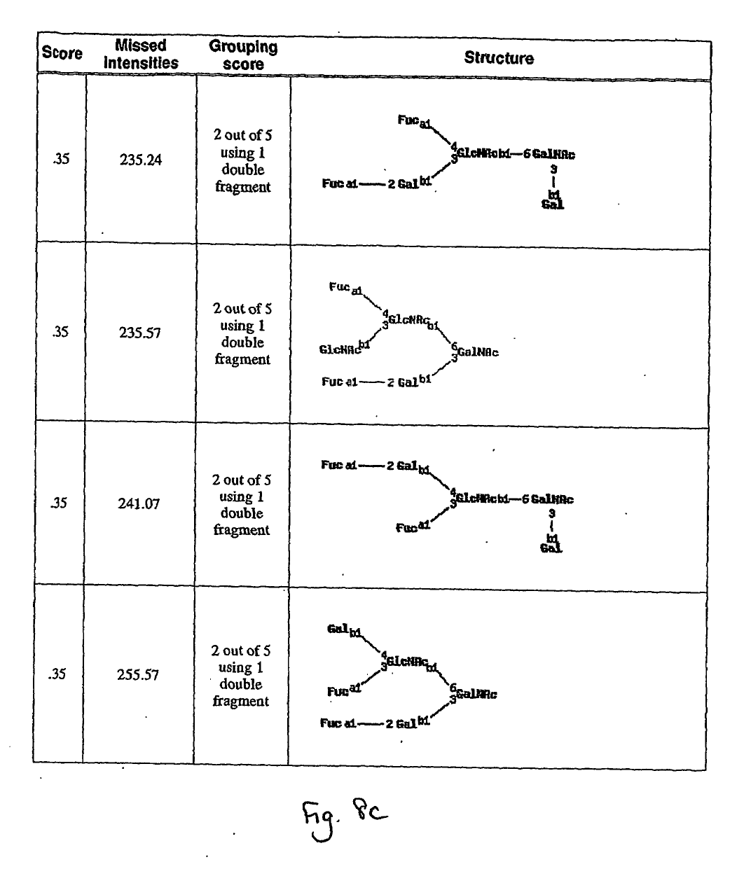

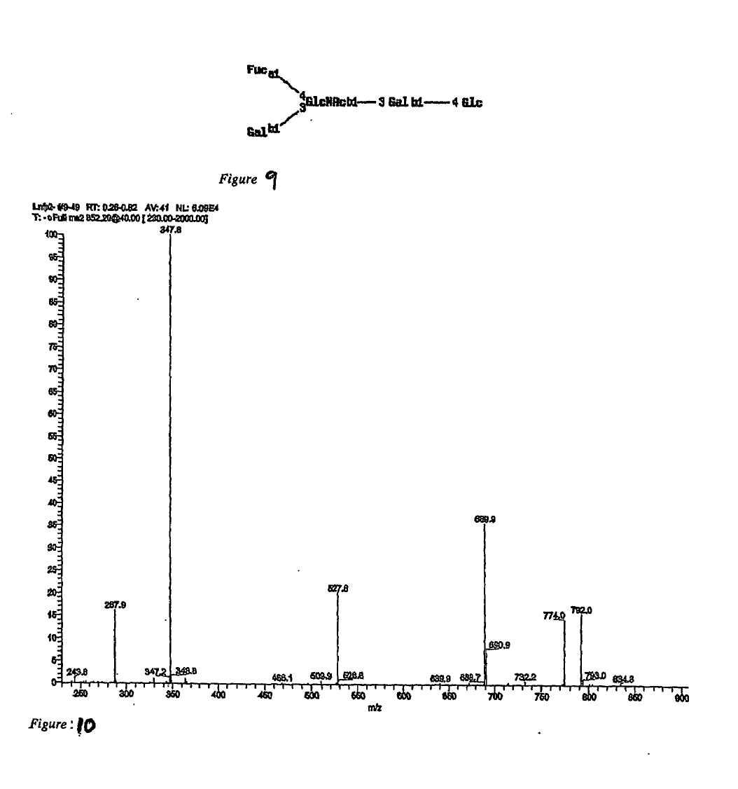

FIGS. 6 to 8 illustrate a first example. The oligosaccharide structure which is empirically fragmented is shown in FIG. 6. FIG. 7 shows its m/z spectra. FIGS. 8a to 8c show a table of results illustrating how the method can distinguish between two isoforms of structure when the grouping score is the same by comparing the sum of the missed intensities with the first structure being the correct structure and having a lower total sum of missed intensities despite both structures having the same score of 0.8 as determined by equation 1.

### EXAMPLE 2

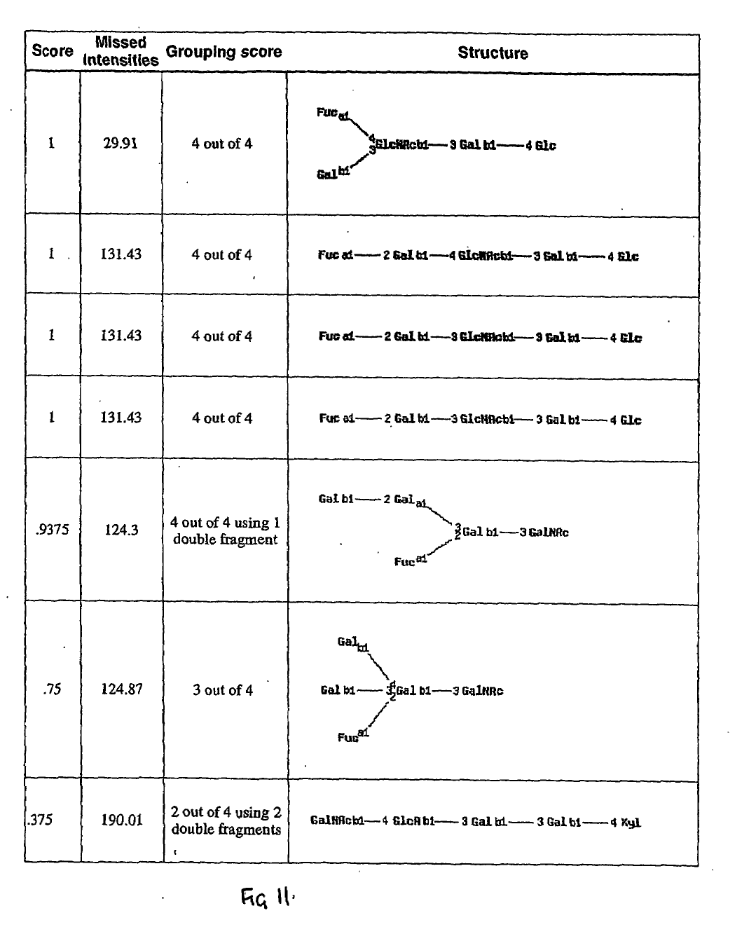

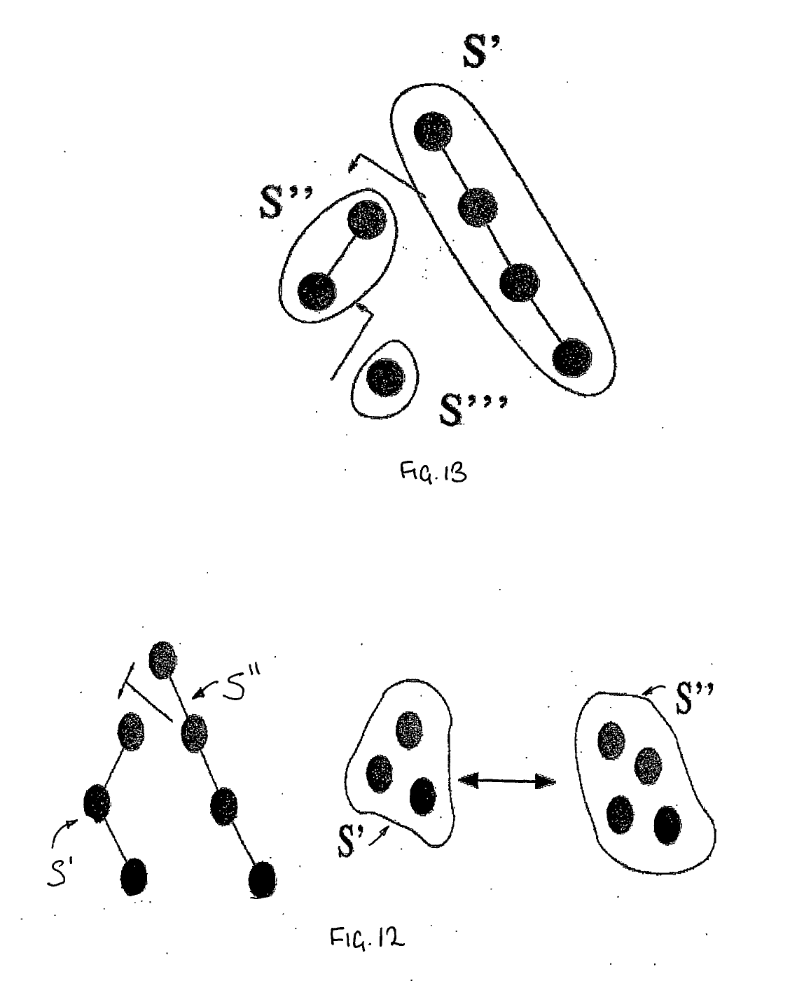

FIGS. 9 to 11 illustrate a second example. The oligosaccharide structure which is empirically fragmented is shown in FIG. 9. FIG. 10 shows its m/z spectra. The first result on this table is correct as it has both a perfect grouping score and the lowest number of missed intensities.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for characterising the structure or sub-structure of a glycan or glycan derivative, comprising the steps of:
experimentally deriving the mass of an unidentified glycan molecule; comparing the mass of the unidentified glycan molecule with defined glycan structures to select candidate structures for the glycan molecule;
experimentally deriving the mass of fragments of the glycan molecule;
conducting theoretical fragmentation of the selected candidates;
matching the mass of the fragments of the unidentified glycan molecule with the mass of fragments theoretically derived from the candidate structures;
scoring to produce ranked confidence scores for each of the candidate structures by comparing the masses of the experimentally derived fragments with the masses of the theoretically derived fragments; and:
if insufficient confidence is obtained in the highest ranked score, further including the step of repeating the process by taking into account more complex cleavage patterns in the theoretical fragmentation step, or by obtaining further fragments.

2. A method as claimed in claim 1 wherein the initial fragment data set used for comparison with the experimentally determined mass consists only of fragments that are the result of 1-cleavage fragmentation.

3. A method as claimed in claim 2 wherein the initial fragment data set also includes 2-cleavage events which are formed exclusively from glycosidic cleavage types.

4. A method as claimed in claim 1 wherein scoring is carried out using the algorithm
Score=(a−0.25b)/(m−1)
where a is the number of cleavage points assigned to 1-cleavage events, and b is the number of cleavage points assigned to 2-cleavage fragments.

5. A method as claimed in claim 1 wherein scoring is carried out utilising a segmentation scoring method to produce ranked confidence scores for at least one of the candidate structures by counting the number of possible conformations for a glycan identified by a set of matching oligosaccharide fragments and assessing the quality of match for the candidate structure by determining how well a particular conformation is supported by the evidenced fragments.

6. A method for characterising the structure or sub-structure of a glycan or glycan derivative as claimed in claim 5 wherein the segmentation scoring method is used for a plurality of the candidate structures.

7. A method for characterising the structure or sub-structure of a glycan or glycan derivative as claimed in claim 5 wherein the score for ordered segments arising from 1-cleavage fragmentation is calculated to be the number of arrangements for each segment multiplied by the minimum number of points that each segment can attach to the other segment.

8. A method for characterising the structure or sub-structure of a glycan or glycan derivative as claimed in claim 7 wherein the score, is calculated as the number of arrangements of monosaccharides in the segment, multiplied by the number of points that an ordered segment will attach to.

9. A method for characterising the structure or sub-structure of a glycan or glycan derivative as claimed in claim 7 wherein additional information from 2-cleavages that span the boundary between two segments is used to reduce the possible number of positions that the segment can be connected.

10. A method for characterising the structure or sub-structure of a glycan or glycan derivative, comprising the steps of:
experimentally deriving the mass of an unidentified glycan molecule;
comparing the mass of the unidentified glycan molecule with defined structures to select candidate structures for the glycan molecule;
experimentally deriving the mass of fragments of the glycan molecule;
conducting theoretical fragmentation of the selected candidates;
matching the mass of the fragments of the unidentified glycan molecule with the mass of fragments theoretically derived from the candidate structures; and
utilising a segmentation scoring method to produce ranked confidence scores for at least one of the candidate structures by counting the number of possible conformations for a glycan identified by a set of matching oligosaccharide fragments and assessing the quality of match for the candidate structure by determining how well a particular conformation is supported by the evidenced fragments.

11. A method for characterising the structure or sub-structure of a glycan or glycan derivative as claimed in claim 10 wherein the segmentation scoring method is used for a plurality of the candidate structures.

12. A method for characterising the structure or sub-structure of a glycan or glycan derivative as claimed in claim 11 wherein the score for ordered segments arising from 1-cleavage fragmentation is calculated to be the number of arrangements for each segment multiplied by the minimum number of points that each segment can attach to in its next segment.

13. A method for characterising the structure or sub-structure of a glycan or glycan derivative as claimed in claim 12 wherein the score is calculated as the number of arrangements of monosaccharides in the segment, multiplied by the number of points that an ordered segment will attach to.

14. A method for characterising the structure or sub-structure of a glycan or glycan derivative as claimed in claim 13 wherein additional information from 2-cleavages that span the boundary between two segments are used to reduce the possible number of positions that the segment can be connected.

15. A method for characterising the structure or sub-structure of a glycan or glycan derivative as claimed in claim 13 including the step of accounting for uneven sub-segment size and multiple independent cleavage events.

16. A method for characterizing the structure or sub-structure of a glycan or glycan derivative as claimed in claim 15 wherein redundant fragments and, when known, chemically impossible fragmentations are omitted to reduce the amount of fragments and data to be processed.

17. A method for characterising the structure or sub-structure of a glycan or glycan derivative as claimed in claim 14 wherein the score is calculated using the equation:
$$score ( segment ) = \frac{\begin{matrix}arrangements ( subsegments ) \times \\ {\prod }_{s ∈ subsegments} score ( s ) \times number of attachments points\end{matrix}}{number of anchoring segments}$$
